(19) United States
(12) Patent Application Publication
(10) Pub. No.: US 2026/0273392 A1
(43) Pub. Date: Sep. 17, 2026

(54) AI-ASSISTED USER INPUT FOR ACCESSIBILITY

(71) Applicant: SONY INTERACTIVE ENTERTAINMENT INC., Tokyo (JP)

(72) Inventors: Alex Song, Palo Alto, CA (US); Daniel HIATT, San Francisco, CA (US); Mayu WATANABE, Los Angeles, CA (US); Chris THIELBAR, EI Cerrito, CA (US)

(21) Appl. No.: 19/079,249

(22) Filed: Mar. 13, 2025

(51) Int. Cl. A63F 13/22; A63F 13/53; A63F 13/79

(52) U.S. Cl. CPC A63F 13/22; A63F 13/53; A63F 13/79

(57) ABSTRACT

System and method herein use AI model-generated control outputs to improve game controllers and user's video game experiences. The system is configured receive, from a controller including controls manually actuatable by a user, controls actuation information (e.g., left trigger, left button, left joystick actuation, etc.) associated with a video game, and determine accessibility information of the user that indicates a limitation to manual actuation of the controller (e.g., injury to left causing less than 50% actuation of left controls). A control output is generated by using an artificial intelligence (AI) model. The AI model is trained to assist video game users with controller inputs in association with accessibility limits for using the controllers, and generate control outputs based on the controls actuation information and the accessibility information. The control output can be used to cause control of executing the video game.

### BACKGROUND

Video games are an immersive form of entertainment. Whether played alone or in groups over the internet, video games can be challenging and engaging. Video games can be operated using an input device such as a video game controller. Control inputs from the controller can be affected if a user has limited accessibility or difficulty operating the buttons of the controller. This difficulty in operating the controller can negatively impact the video game outcomes and video gaming experience alone or in groups.

### BRIEF DESCRIPTION OF THE DRAWINGS

Various embodiments in accordance with the present disclosure will be described with reference to the drawings, in which:

FIG. 1 illustrates a computer system including a trained machine learning (ML) model, according to various embodiments of the present disclosure.

FIG. 2 illustrates the trained machine learning model of FIG. 1 configured to generate control outputs.

FIG. 3 illustrates an AI accessibility agent of FIG. 1 configured to generate control output for a video game using the trained ML model.

FIG. 4 illustrates the AI accessibility agent of FIG. 1 predicting and overlaying control outputs on a video during a gameplay.

FIG. 5 illustrates an example inputs and outputs used for training of a ML model, according to various embodiments of the present disclosure.

FIG. 6 illustrates is an example flow chart for generating AI-assisted control outputs, according to various embodiments of the present disclosure.

FIG. 7 illustrates an example of a video game controller, according to some embodiments of the present disclosure.

FIG. 8 illustrates another example of a video game controller, according to some embodiments of the present disclosure.

FIG. 9 illustrates an example of a computer system suitable for implementing techniques of the present disclosure, according to some embodiments of the present disclosure.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure are directed to, among other things, artificial intelligence (AI) system including an AI model configured to generate control outputs or modified user inputs. For example, the AI model is trained to generate the control outputs to compensate for user's accessibility issues when actuating controls of a video game controller. The control inputs can indicate that the user may have accessibility issues when operating the gaming controller due to an injury, a disability or other accessibility related factors. For example, the user may have difficulty actuating a left button, move a left joystick, press a trigger, or other controls of the controller. As such, these controls inputs may not be as intended by the user and affect the video gaming experience. According to the present disclosure, a video game system can be configured to generate control outputs using an artificial intelligence (AI) model using the control inputs from the controller. The AI model is pre-trained at least partially on controls actuation information and accessibility data associated with the controller. When the user actuates left button, moves a left joystick, presses a trigger, or other controls of the controller, the AI model generates control outputs or modified controls inputs. These AI-generated outputs compensate for the accessibility issues during a video gameplay. These control outputs can cause a desired effect on execution of the gameplay thereby improving the gaming experience.

Embodiments of the present disclosure provide several technological improvements resulting in many practical uses. For example, the AI model can be integrated or used as a service (e.g., via an application programming interface or some other interface) with an application executing on a user device. The overall functions of the video gaming application and/or controller can be substantially improved.

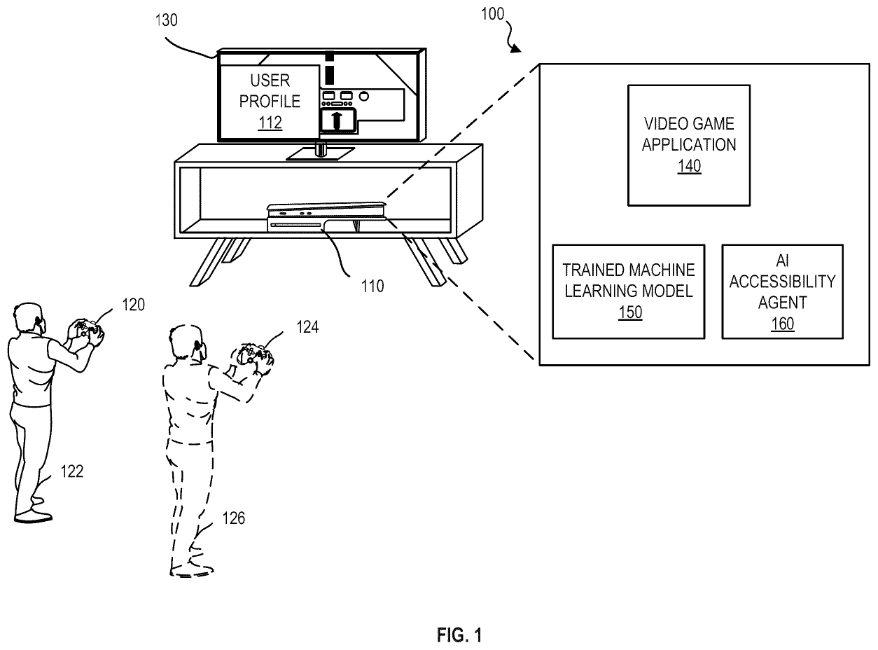

FIG. 1 illustrates a computer system that involves the use of a trained machine learning (ML) model to generate control outputs, according to embodiments of the present disclosure. As illustrated, the computer system 100 includes a video game console 110, a video game controller 120 (or 124), and a display 130. Although not shown, the computer system 100 may also include a backend system, such as a set of cloud servers, that is communicatively coupled with the video game console 110. The video game console 110 is communicatively coupled with the video game controller 120 (e.g., over a wireless network) and with the display 130 (e.g., over a communications bus). Video game player 122, 126 can operate the video game controller 120, 124, respectively, to interact with the video game console 110. These interactions may include user inputs for playing a video game presented on the display 130, interacting with a user profile 112 presented on the display 130, and/or interacting with other applications of the video game console 110.

In an example, the player 122 may have accessibility limitations and have difficulty actuating controls via the controller 120, while the player 126 may be regular with no difficulties with handling the controller 120. The accessibility limitations may be a result of e.g., an injury to a limb, disability, physical conditions causing reduced mobility, environmental conditions affecting the player's mobility or capability to operate the controller 120, or other factors causing difficulty in using the controller 120. For example, the player 122 may have an injured left finger or no left finger that can cause difficulty or prevent the player 122 from inputting full range of left-hand controls (e.g., movement of left joystick) via the controller 120. As such, control inputs from the player 122 may fall short of desired video game actions and negatively affect the video gaming experience for both the players 122 and 126.

The video game console 110 includes one or more processors and one or more memories (e.g., a non-transitory computer-readable storage medium) storing computer-readable instructions that can be executed by the one or more processors and that, upon execution by the one or more processors, cause the video game console 110 to perform various operations (e.g., operations related to various applications). In various embodiments, the computer-readable instructions can correspond to program codes for the various applications of the video game console 110 including a video game application 140, a trained ML model 150, and an artificial intelligence (AI) accessibility agent 160.

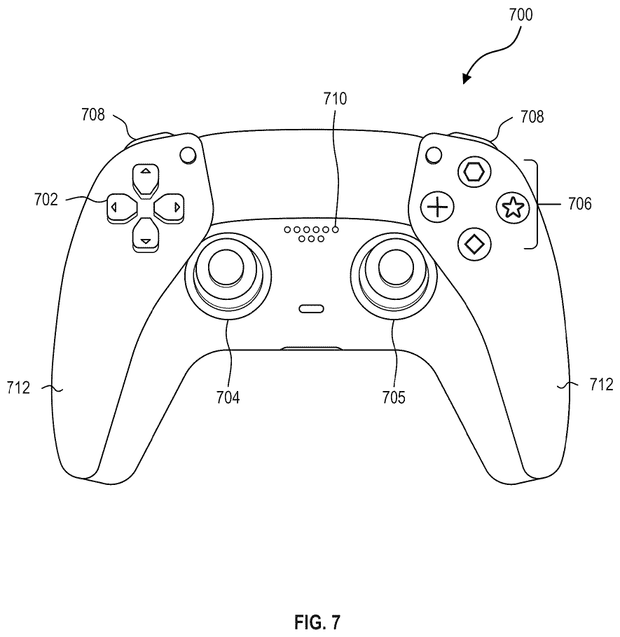

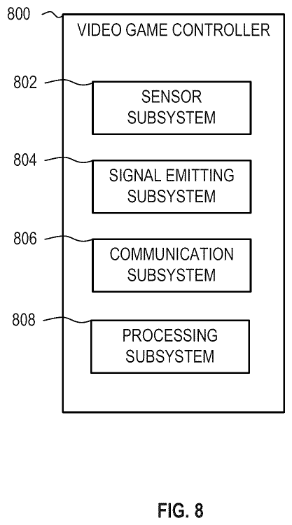

The video game controller 120 (or 124) is an example of an input device. The video game controller 120 may allow the user 122 (or 124) to interact with one or more GUIs presented by the video game console 110 on the display 130. For example, using one or more directional control inputs (e.g., a joystick and/or a directional pad) the user can navigate to and within various menus, dashboards, interact with video game content, and UI elements. Other types of the input device are possible including, a keyboard, a touchscreen, a touchpad, a mouse, an optical system, a microphone, a camera, or other user devices suitable for receiving input of a user. For example, a microphone may allow the user 122 to interact with the GUIs using various voice commands. As another example, a camera may allow the user 122 to interact with the GUIs using various gesture commands. An example of the video game controller 120 is further discussed in detail with respect to FIGS. 7 and 8.

The video game application 140 can generally represent a computer application executable to present video game content, user profile, receive user interaction with the video game content, and accordingly update the video game content. Upon an execution of the video game application 140 by the video game console 110, a rendering process of the video game console 110 presents video game content (e.g., illustrated as a shooting game content, a car race video game content) on the display 130. The user 122 (and/or 124) can interact with the video game content by providing user input using the video game controller 120 (and/or 124). For example, a user may push or move a particular key or button to achieve a task or a goal presented by the video game content.

In some embodiments, the video game application 140 can present a user profile 112 via user interfaces (UIs) in a GUI of the display 130. One or more UIs of the UIs related to the user profile 112 can include accessibility information related to accessibility limitations of that particular user. For example, the accessibility information can include, but is not limited to, a disability type, accessibility limitations such as a percentage range of motion or reach, conditions affecting user's mobility, an accessibility indicator that may be activated or deactivated, or other accessibility related factors. As an example, a user 122 may have accessibility limitations due to injury or disability, while the user 124 may play regularly without accessibility limitations. In this case, the user 122 may desire some accessibility support to allow regular gameplay alone or in a group with the user 124 (regular gameplay referring to a baseline of a general population of video game players). Hence, the user 122 may provide the accessibility information in its user profile and request activation of accessibility support. In some embodiments, this accessibility support can be implemented as the trained ML model 150, the AI agent 160, or a combination thereof. The trained ML model 150 and/or the AI agent 160 may modify the user inputs from the controller 120 and provide such modified inputs to the video game application 140 to perform the operations of a video game content.

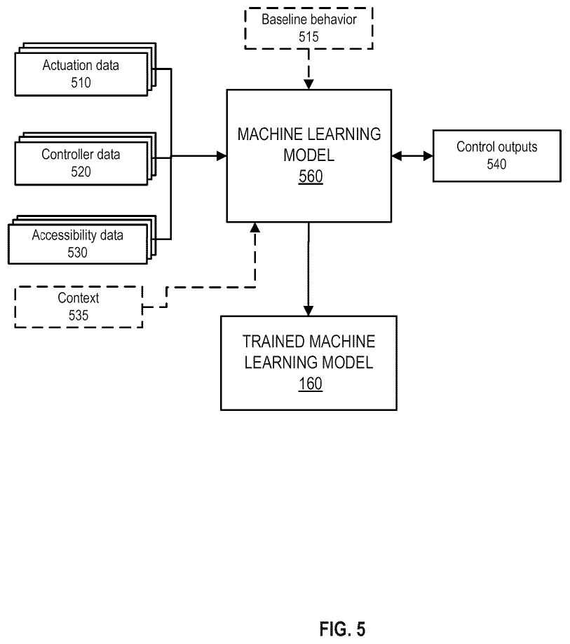

The trained ML model 150, which may also be referred as an AI model, can be configured to receive control inputs from the controller 120, and generate control outputs or modified control inputs. The trained ML model 150 can include a neural network, an arrangement of neural networks (e.g., a genAI model, an encoder, a transformer, a decoder, etc.), and/or any type of AI models suitably trained for generating control outputs based on user inputs provided via a controller (e.g., 120). An example training process is discussed with respect to FIG. 5. The control outputs can be used directly or converted to a data format that can be used to perform an operation or task within a video game presented by the video game application 140. The trained ML model can be deployed on a gaming console, a cloud server accessible to the gaming console 110, or the controller 120 without limiting the scope of the present disclosure.

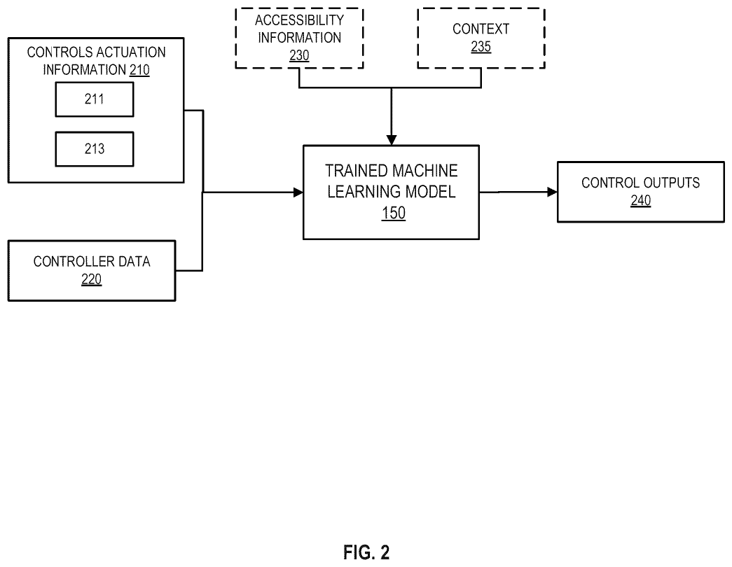

Referring to FIGS. 1 and 2, the trained ML model 150 can assist video game users with controller inputs in association with one or more accessibility limits while using a controller (e.g., 120 in FIG. 1). The trained ML model 150 can generate control outputs 240 using controls actuation information 210 as one of the inputs. In some embodiments, the controls actuation information 210 can include, but not limited to, one or more controls actuated by the user (e.g., 122, 124), an amount of actuation of the one or more controls, timing of the actuation of the one or more controls, duration of the actuation of the one or more controls, or other controls related information.

In some embodiments, the controls actuation information 210 can include a first control actuation information associated with accessibility limitations (e.g., an injured hand, or disability) of controls of the controller (e.g., 120), and a second control actuation information 213 associated with regular controls of the controller (e.g., 120). For example, the user 122 may have injury to his left hand or may have missing fingers on the left hand. In this case, the first controls actuation information 211 may correspond to inputs received from a left group of controls on the controller (e.g., 120), and the second controls actuation information 213 may correspond to inputs received from a right group of controls on the controller (e.g., 120).

As an example, the first controls actuation information 211 may include, but is not limited to, a reduced manual actuation of the controls relative to a baseline controls actuation related to users without the limitation, an excessive manual actuation of the controls relative to the baseline controls actuation related to the users without the limitation, no actuation of the controls, or other controls information associated with manual actuation of controls of the controller (e.g., 120). The trained ML model 150 can generate the control outputs 240 that compensates for shortcoming related to controls actuations. For example, the control outputs 240 may generate an amplified digital actuation corresponding to the reduced manual actuation of the controls, a reduced digital actuation corresponding to the excessive manual actuation of the controls, or the baseline controls actuation corresponding to no actuation of the controls. The amount of compensation to the manual actuation of the controls determined by the trained ML model can be user-specific, controller-specific, and/or game context specific.

In some embodiments, the trained ML model 150 can generate the control outputs 240 by additionally using controller data 220. For this, the trained ML model 150 may be trained based on controller data 220 such as hardware information associated with different controller as one of the training inputs. For example, the controller data 220 may include, but not limited, to model number and/or type of controller, controls (e.g., type of buttons or inputs) information associated with the controller, or other hardware information associated with the controller. The controller data 220 can be useful so that gameplay ability will not be limited to a particular controller. This way, the trained ML model 150 can be controller agnostic so that the user 122 can play using different controllers thereby providing flexibility of using different controllers while improving gameplay experience. Although being controller agnostic, the trained ML model 150 can still generate the control output 240 relevant to or specific to a particular controller being used by the user 122. For example, some controllers may use joystick to input directional inputs, while some controller may user buttons. Accordingly, different control output may need to be generated based on whether the control input is from a joystick or from a button. In some embodiments, each type of controls can have different accessibility limitations. Thus, the trained ML model 150 can suitably account for accessibility limits related to particular types of controls.

In some embodiments, the trained ML model 150 can generate the control outputs 240 by additionally using the accessibility information 230 as an input. For example, the accessibility information 230 may be received from the user profile (e.g., 112 in FIG. 1), or other user interfaces configured to input accessibility information prior to a gameplay. In some embodiments, the accessibility information 230 may be predicted by another AI model trained based on user inputs via the controller 120, the user's history of gameplay, the user's profile, or other accessibility data. For this, the trained ML model 150 can be trained based on accessibility information of different users (see FIG. 5). As such, the control output can compensate for the accessibility limitation to the manual actuation by the user (e.g., 122) of the controller (e.g., 120). For example, the accessibility information 230 may include, but is not limited to, limits (e.g., a percentage, or a range of values) related to an amount of controls actuations, muscle strength information, hand stability or vibrations profile, duration of operation of the controller (e.g., 120), binary information whether one or more controls can be actuated or not actuated by the user, other accessibility limitations.

In some embodiments, the trained ML model 150 can generate the control outputs 240 by additionally using application specific context 235. For this, the trained ML model 150 may be trained based on context information of video games as one of the training inputs. This way, the trained ML model can generate the control outputs 240 relevant to a particular video game context by inputting context information of the video game to the trained ML model 150. For example, the context information may include, but is not limited to, a type of the video game, different video game operations generic to several video games, video game operations specific to a video game, different goals to be achieved in the video game, etc.

In some embodiments, the AI accessibility agent 160 can be configured to convert the control outputs (e.g., 240 in FIG. 2) from the trained ML model to gameplay actions or commands associated with the video game. In some embodiments, the AI accessibility agent 160 can receive at least one of inputs related to the gameplay (e.g., context of the gameplay), user behavior or responses during the gameplay, user accessibility limits, the controls of the controller 120 actuated by the user, or other user or gameplay related data. Based on the inputs, the AI accessibility agent 160 can analyze the gameplay, user behavior during the gameplay, make decisions related to gameplay operations for a particular video game based on the inputs from the controller 120 and/or control outputs (e.g., 240) generated by the trained ML model 150. In some embodiments, the AI accessibility agent 160 can include the trained ML model 150, and/or additional AI models. In some embodiments, the AI accessibility agent 160 can control execution of the trained ML model 150 so that relevant control outputs (e.g., 240) are generated by the trained ML model 150 on-demand. This can improve computational efficiencies during the gameplay and improve response time of a gameplay action after user provides control inputs via the controller 120.

In some embodiments, the AI accessibility agent 160 associated with the user 122 can be activated via the user profile 112. For example, the AI accessibility agent 160 and the trained ML model 150 can be activated locally if on the console 110. As another example, if the trained ML model 150 is deployed on a computing cloud, a remote execution on the cloud can be requested via the controller 120. In some embodiments, the AI accessibility agent 160 may automatically activate and run in background when the user 122 is logged in a video game.

In some embodiments, the AI accessibility agent 160 can compare the controls actuation information (e.g., 210 in FIG. 2) with baseline controls actuation information to identify a subset of controls actuation information (e.g., 211) associated with user accessibility limitations. The baseline controls actuation information can be associated with users without accessibility limitations and stored in a memory of the console, cloud, or other networked computing device accessible via a user log-in credentials.

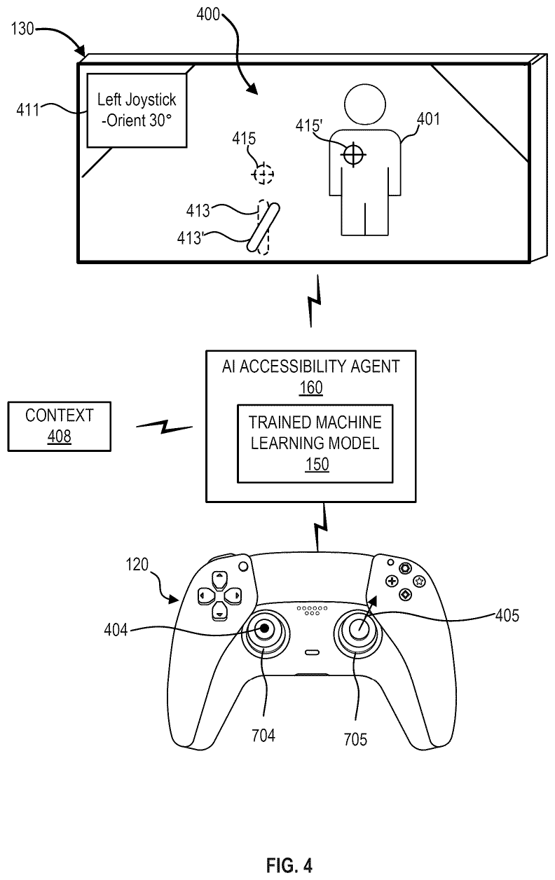

In some embodiments, the AI accessibility agent 160 can be configured to automatically deactivate the AI model in a multi-player video game; or deactivate the AI model based on user input of the user (e.g., 122 or 124). In some embodiments, an indication (e.g., visual, audio, or others) can be provided to a player in a multi-player video game that the AI accessibility agent 160 is activated for a particular user. For example, a visual indicator may be provided on the video game (e.g., 400 in FIG. 4), a visual indicator can be provided before starting the video game, and/or an audio signal can be provided to one or more players that are playing with the user.

In some embodiments, the AI accessibility agent 160 can be configured to adapt manual actuation of the controls based on user's accessibility information, analyze user inputs or behavior during the gameplay, or other factors related to user's accessibility. For example, the AI accessibility agent 160 may increase a tension or decrease the tension on a button or joystick of the controller 120 based on the accessibility limitations. This way, the user 122 with accessibility issues can more easily input controls via the controller 120.

Accordingly, using the trained ML model 150 and/or the AI accessibility agent 160, the controller 120 can be associated with two types of controls: “soft” controls and “hard” controls. Soft controls augment/update/replace the user input. Soft controls are all determined or implemented in software. Hard controls modify the hardware configuration of the controller 120 (e.g., changing the physical motion range of a button, etc.). In some embodiments, both the soft controls and the hard controls can be generated for the controller 120.

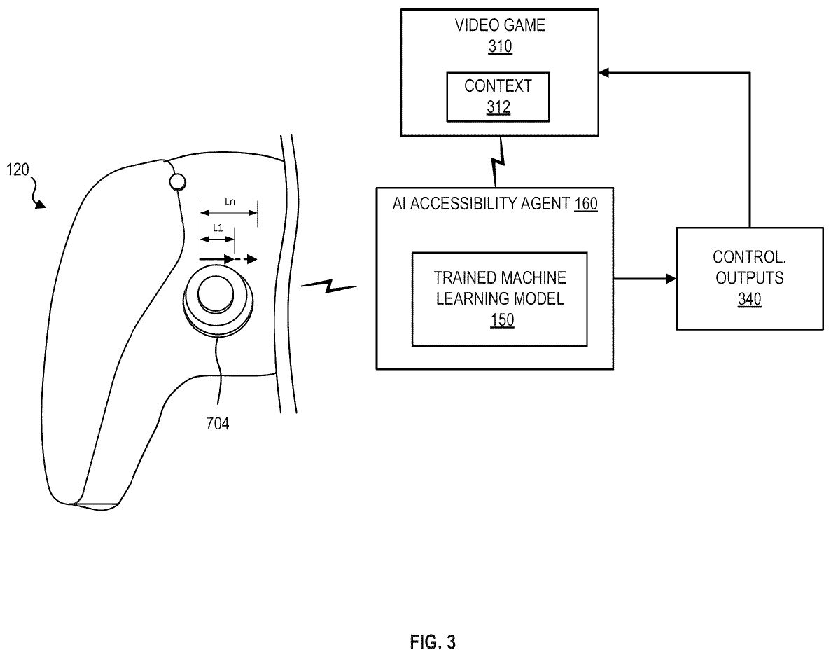

FIG. 3 illustrates an example implementation and use of AI accessibility agent 160. As illustrated, the AI accessibility agent 160 can be configured to receive controls input from the controller 120, a context 312 of a video game 310, and generate control outputs 340 for a video game using the trained ML model 150. As an example, a control input can be an amount of movement L1 of a left joystick 704 of the controller 120. The context 312 can be an object information (e.g., a gun, a car, a person, or other video game element) to be moved in the video game 310. In some embodiments, the amount of movement L1 can be less than a desired amount of movement Ln of the joystick 704 due to accessibility limitations of a user (e.g., 122). The AI accessibility agent 160, using the trained ML model 150 and accessibility information related to the user, can generate a modified input or a control output that corresponds to the desired movement (e.g., Ln). The AI accessibility agent 160 can further generate a control output 340 based on the context and related action to be performed in the video game 310. For example, the controls output generated by the trained ML model 150 corresponding to the desired movement (e.g., Ln), can be converted to a movement of an object within the video game by an amount corresponding to the desired movement (e.g., Ln). In some embodiments, the AI accessibility agent 160 can generate a control output 340 comprising a control signal to adaptively adjust a tension on the joystick 704 so that the joystick 704 move by the desired amount Ln, even though the user is able to move the joystick 704 by the amount L1.

Referring back to FIGS. 1 and 2, the AI accessibility agent 160 can be configured to predict controls desired to be input by the user 122 based on the first controls actuation information 211 (see FIG. 2) and/or the second controls actuation information 213 (see FIG. 2) and context of a video game. The AI accessibility agent 160 can further overlaying control outputs and/or predicted controls on the display (e.g. 130).

FIG. 4 illustrates an example application of the AI accessibility agent 160 in a video game 400. In the illustrated embodiment, the AI accessibility agent 160 can be configured to predict a desired control intended by the user, generate a corresponding control output, and overlay the control output on a video game 400 during a gameplay. Video game data resulting from the execution of the video game 400 may be displayed on the screen 130. As an example, the video game data may include game objects such as a person 401, a gun 413, a crosshair 415, or other graphical elements. This video game data can be input as context information 408 to the accessibility agent 160. The context information 408 may further include functions or operations associated with the game objects so that the AI accessibility agent 160 can accordingly generate suitable control outputs in cooperation with the controls input received from a game controller (e.g., 120).

The AI accessibility agent 160 can receive controls actuation information from the controller 120. As an example, the user (e.g., 122 in FIG. 1) may have full range of motion for the right-hand, and limited accessibility for the left-hand. Accordingly, the user (e.g., 122) may not be able to actuate a left joystick 704 to provide a first directional input 404 at all, but can actuate a right joystick 705 normally to provide a second directional input 405. The movements of the joysticks 704, 705 can correspond to movement of the gun 413 and the crosshair 415 in the video game 400. The control actuation information can include an amount of the first directional input 404 (e.g., 0), and an amount of the second directional input 405 (e.g., 2 mm along an upward direction).

Based on the control actuation information (e.g., 404 and 405), the context information (e.g., 408), and the accessibility information, the AI accessibility agent 160 can predict desired controls input associated with the left-hand controls. For example, the AI accessibility agent 160 may predict, using the trained ML model 150, that the user intended to move the left-hand joystick 704 along 30 degrees relative to a vertical axis, but was unable to provide input with the left-hand due to associated accessibility limitations. The AI accessibility agent 160 can overlay predicted control information 411 e.g., “Left Joystick-Orient 30°” on the screen 130 in the video game 400 during the gameplay. Furthermore, the AI accessibility agent 160 can overlay a graphical element corresponding the predicted control 411. For example, the graphical elements can be a predicted gun 413′ oriented at 30° and the crosshair 415′ positioned on the person 401. In other words, the AI accessibility agent 160 generated predicted outputs and converted the predicted outputs to actions in the video game 400 indicating that the user intended to point the gun 413 at the person 401 so that the crosshair appear on the person 401.

Although not illustrated, additionally or alternatively, the system 100 (in FIG. 1) can include a network node (e.g., a set of servers, a cloud computing platform hosted in a data center, etc.) remote from the user device and accessible to the user device over a network. The applications (e.g., 140 in FIG. 1) can be executed on the backend system (e.g., the cloud servers) and/or their execution can be distributed between the video game console (e.g., 110) and the backend system. The trained ML model (e.g., 150) can be hosted locally on a user device such as a controller (e.g., 120), laptop, phone, etc. Alternatively, the trained ML model (e.g., 150) can be hosted remotely at the computer network and accessible to the user device via an interface (e.g., an API). In this case, the trained ML model 150 can be trained initially by using the network node, then an instance thereof fine-tuned on the network node fine-tuned using the user specific data associated with a particular controller, one or more video games, and this instance can be stored in association with the user profile (e.g., 112) at the network node and segregated from similar AI-model instances fine-tuned for other users. It may be possible that the trained ML model 150 can be distributed between the user device and the network node.

Furthermore, although not illustrated for simplicity, the user profile (e.g., 112) can include user data such as a user account identifier, account data, and accessibility information. Generally, the user data can be controlled by the user and its collection and use is under control of the user and meets all regulatory requirements for data privacy, collection, and storage. The user account identifier and account data can enable various computing services to be provided to the user on an account-basis.

FIG. 5 illustrates an example inputs and outputs for training of a ML model 560 for generating control outputs 540 associated with accessibility limitations for a video game controller, according to various embodiments of the present disclosure. In an example, the machine learning model 560 can include a neural network, an arrangement of neural networks (e.g., a generative AI (genAI) model), and/or any type of AI models suitable for implementing the techniques of the present disclosure. The ML model 560 can be trained using extensive training data from different sources associated with playing different video games, resulting in the trained ML model 150. In some embodiments, the trained ML model 150 may be is further trained (e.g., fine-tuned) by using user specific and/or application-specific training data, resulting in a fine-tune AI model. The ML model 560 can be trained using supervised learning (and/or possibly unsupervised learning), which involves feeding the model vast amounts of data from the sources.

In some embodiments, the training data can include actuation data 510, controller data 520, and accessibility data 530. Additionally or alternatively, user-specific data, application-specific data may also be provided to further fine-tune parameters of the ML model 560. As an example, the actuation data 510 can be collected from a plurality of controllers, and associated with a plurality of users using these controllers. The plurality of controllers can be a plurality of same controller (e.g., 120) and/or different types of controllers. The controller data 520 can include hardware information, type of controls, or other information associated with the plurality of controllers. The accessibility data 530 can include accessibility limitations, disabilities, or other data that limits accessibility of controllers for the plurality of users. The accessibility data 530 can be collected from different users having different types of limitations or disabilities, and/or same user playing different video games.

Additionally or alternatively, the training data can include baseline behavior data 515 associated with a user, and/or context data 535 associated with one or more video games played by a user or a plurality of users. As an example, the baseline behavior data 515 can include gameplay data associated with a particular user. The baseline behavior data 515 can be used to analyze intentions of the particular user during a gameplay so that the ML model 560 or the AI accessibility agent (e.g., 160) can be appropriately determine whether the particular user is deviating from a baseline behavior due to new or existing accessibility limits. The context data 535 can include information related to a particular video game. For example, the context data 535 can include a game title, objects in the game and their movement characteristics, gaming goal or objectives, or other gaming related data.

During the training process, the ML model 560 processes the data to learn patterns and relationships between the accessibility data, and actuation data by adjusting these weights to minimize the prediction error. In some embodiments, the ML model 560 can further process the data to additionally learn patterns and relationships between the controller data 530, the context data 530 and the baseline behavior data 515. The training process can involve breaking down data into smaller units, a process known as tokenization, and mapping these units into high-dimensional vectors through embedding, allowing the model to understand the context and/or semantics of the data. The training process includes multiple iterations of feeding data into the model, validating its predictions, and fine-tuning the parameters to improve performance and accuracy. As a result, the trained ML model 150 can generate coherent and contextually appropriate outputs 540 (e.g., a predicted amount of controls actuation, a predicted movement of a video game object, a predicted amount of input corresponding to accessibility limit, etc.).

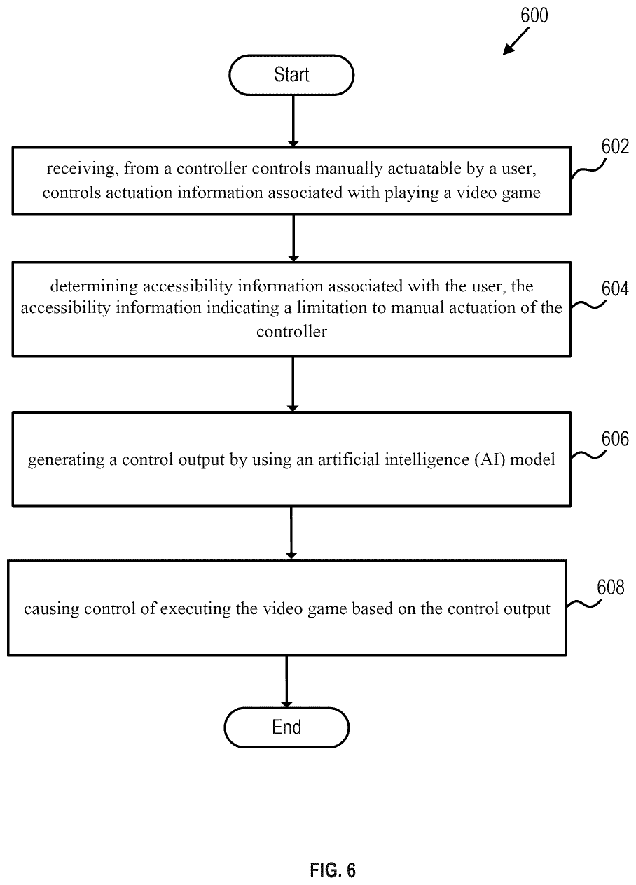

FIG. 6 illustrates is an example flow chart for generating AI-assisted control outputs, according to various embodiments of the present disclosure. The operations of a flow 600 can be implemented as hardware circuitry and/or stored as computer-readable instructions on a non-transitory computer-readable medium of a computer system, such as any of the computer systems described herein (e.g., a user device and/or a server). As implemented, the instructions represent modules that include circuitry or code executable by a processor(s) of the computer system. The execution of such instructions configures the computer system to perform the specific operations described herein. Each circuitry or code in combination with the processor represents a means for performing a respective operation(s). While the operations are illustrated in a particular order, it should be understood that no particular order is necessary and that one or more operations may be omitted, skipped, and/or reordered.

In an example, the flow 600 includes operation 602, where the computer system receives controls actuation information associated with playing a video game from a controller having controls manually actuatable by a user. For example, referring to FIGS. 1 and 2, the control actuation information 210 is related to controls of the controller 120 manually actuated by the user 122. For example, the controls actuation information 210 can include a reduced manual actuation of the controls relative to a baseline controls actuation related to the users without accessibility issues, an excessive manual actuation of the controls relative to the baseline controls actuation related to the users without accessibility issues, or no actuation of the controls of the controller 120.

In an example, the flow 600 includes operation 604, where the computer system determines accessibility information associated with the user, the accessibility information indicating a limitation to manual actuation of the controller. For example, as discussed with respect to FIGS. 1 and 2, accessibility information (e.g., 230) can be determined from the user profile 112. In some embodiments, the accessibility information (e.g., 230) can be determined based on comparison with a baseline behavior (e.g., 515 in FIG. 5) of the user (e.g., 122).

In an example, the flow 600 includes operation 606, where the computer system generates a control output by using an artificial intelligence (AI) model, the AI model trained to assist video game users with controller inputs in association with one or more accessibility limits for using controllers, the control output generated based on the controls actuation information and the accessibility information. For example, referring to FIGS. 1 and 2, the AI model (e.g., 150) can generate an amplified digital actuation corresponding to the reduced manual actuation of the controls, a reduced digital actuation corresponding to an excessive manual actuation of the controls, or the baseline controls actuation corresponding to no actuation of the controls.

In an example, the flow 600 includes operation 608, where the computer system causes control of executing the video game based on the control output. For example, as discussed with FIG. 4, the AI accessibility agent 160 can be configured to convert the control outputs generated by the trained ML model 150 into an action or control of an operation in the video game (e.g., 400). In some embodiments, causing the control of executing the video game can involve inputting a context (e.g., 408 in FIG. 4) of the video game (e.g., 400 in FIG. 4) to the AI model (e.g., 150) or the AI accessibility agent (e.g., 160). Furthermore, the computer system can receive gameplay data (e.g., related to video game objects 401, 413, and 415 in FIG. 4) of the execution of the video game (e.g., 400 in FIG. 4) for the user (e.g., 122).

In some embodiments, based on the context, at least a subset of the controls actuation information (e.g., 404) can be identified in relation to the context (e.g., 408) of the video game (e.g., 400). Furthermore, the computer system can predict a video game action relevant to the gameplay data and the subset of the controls actuation information. For example, in FIG. 4, the video game outcome can be to orient the gun to 413′ to move the crosshair 415 to a location corresponding to 415′. The predicted video game action (e.g., location of the crosshair 415′ on the person 401) during the gameplay can be overlaid on to a display screen (e.g., 130). Additionally or alternatively, the control output (e.g., 411 in FIG. 4) that corresponds to an adjusted set of manual actuations (e.g., 404) of the controller (e.g., 120) can be overlaid on the screen (e.g., 130).

In some embodiments, the computer system can cause, based on the control output, a change to an actuation configuration (e.g., Ln in FIG. 3) of the controls of the controller (e.g., 120). In some embodiments, the control output can be used to cause a change to a setting of the video game (e.g., slow down the game, adjust speed of a video game object like a car, reduce visual clutter, etc.). For example, the AI accessibility agent 160 can be configured to change the setting of the video game based on the accessibility information, a reaction time of the user analyzed using the controls actuation information, or other analysis of controller data or gameplay data.

FIG. 7 illustrates an example of a video game controller 700, according to various embodiments. The video game controller 700 can be an example of the video game controller 120 and 124. The controller 700 can include manually actuatable controls or mechanisms for providing input to the video game console 110. For example, the video game controller 700 can include a directional pad 702, a left joystick 704, a right joystick 705, buttons 706, and triggers 708. Any combination of the directional pad 702, one or both of the joysticks 704, 705, one or more of the buttons 706, and one or both of the triggers 708 can be used by an end user (e.g., a video game player) to provide input to the video game console 110. The video game controller 700 can also include handles 712, which can be used to hold or grip the video game controller 700 while an end user operates the video game controller 700 to provide the input the video game console 110. The video game controller 710 can also include ports 710 that enable audio transducers included in the video game controller 700 to record sounds in an environment surrounding the video game controller 700 and emit audio to the environment surrounding the video game controller 700. Although not shown, the video game controller 700 can include other components such as one or more touch sensors for detecting physical touching of the video game controller 700 (e.g., by a human, another video game controller, an electronic device, and the like), display screens for displaying content (e.g., control and video game content) and receiving input to the video game controller 700 (e.g., touchscreen input), light sources (e.g., light emitting diodes) for emitting light and other signals to the environment surrounding the video game controller 700, and the like. The foregoing mechanisms of the video game controller 700 are not intended to be limiting and other mechanisms may be included in the video game controller 700.

FIG. 8 illustrates another example of a video game controller 800, according to various embodiments. The video game controller 800 can be used as the video game controller 120 or 124. In some embodiments, features of the video game controller 800 can be implemented in the video game controller 700 (in FIG. 7). As shown in FIG. 8, the video game controller 800 can include a sensor subsystem 802, a signal emitting subsystem 804, and a communication subsystem 806, and a processing subsystem 808.

The sensor subsystem 802 can include sensors for sensing an operation of the video game controller 800, an external environment of the video game controller 800 (e.g., an environment surrounding the video game controller 800), an internal environment of the video game controller 800 (e.g., an environment within the video game controller 800), and the like. Examples of the sensors included in the sensor subsystem 802 can include, but are not limited to, image sensors, infrared sensors, depth cameras, event detection sensors, light sensors, microphones, sound sensors, audio transducers, position determining sensors, ultrawide band sensors, magnetic sensors, orientation sensors, proximity sensors, accelerometers, gyroscopes, inertial measurement units (IMUs), and the like.

The signal emitting subsystem 804 can include devices for emitting signals. A signal emitted by a device or devices of the signal emitting subsystem 804 can include a light component (e.g., visible and/or infrared light), an audible component (e.g., a sound), and/or a haptic feedback component (e.g., a vibration). Examples of light that can be included as a component of a signal emitted by a device or devices of the signal emitting subsystem 804 include visible light, infrared light, laser light, steady light, strobe light, flashing light, colored light, light patterns, light beams, modulated light, and the like. Examples of audio that can be included as a component of a signal emitted by a device or devices of the signal emitting subsystem 804 include sounds, noises, music, tones, chimes, songs, ringtones, variable volume audio, and the like. Examples of haptic feedback that can be included as a component of a signal emitted by a device or devices of the signal emitting subsystem 804 include vibrations, surface frictions, thermal feedback, electromagnetic feedback, ultrasonic feedback, and the like. Examples of devices included in the signal emitting subsystem 804 can include, but are not limited to, audio transducers such as speakers, light sources such as LEDs, haptic feedback devices such as a vibrator, and others.

The communication subsystem 806 can include various hardware such as circuitry, radios, modules, transceivers, and software for enabling the video game controller 800 to communicate using wireless and/or wired communication. For example, the various hardware and software can enable the video game controller 800 to communicate with a network, a cloud-based storage system, another device such as another video game controller, electronic device, mobile phone, input device, video game console, and the like. The various hardware and software can also enable the video game controller 800 to communication using any wired and/or wireless communication technology, standard, protocol, and the like, and using any kind of network, public or private, wired or wireless, and the like. Examples of such technologies, standards, and protocols include NFC, Bluetooth, IrDA; RFID; Matter; ZigBee; 3G; 4G; 5G; 6G; WLAN; Z-wave; Wi-Fi and Wi-Fi Direct; UWB; USB; ANT and ANT+; UHF; VHF; SCPS; and the like.

The processing subsystem 808 can receive inputs from the sensor subsystem 802, the signal emitting subsystem 804, and the communication subsystem 806 and generate. The processing subsystem 808 can include one or more processors (not shown) and one or more memories (not shown). The one or more processors can read one or more programs from the one or more memories and execute them. Each processor of the one or more processors can be of any type of processor. Examples of processors include, but are not limited to, microprocessors, microcontrollers, graphical processing units, digital signal processors, application-specific integrated circuits, field programmable gate arrays, or any combination thereof. Additionally, each processor of the one or more processors can include multiple cores, arrays, coprocessors, local cache memory layers, and the like. Each memory of the one or more memories can be non-volatile and can include any type of memory or memory device that retains stored information when powered off. At least one memory of the one or more memories can include a non-transitory computer-readable storage medium from which the one or more processors can read instructions. Examples of memories, memory devices, computer-readable storage media include, but are not limited to, include electrically erasable and programmable read-only memory, flash memory, magnetic disks, memory chips, read-only memory, RAM, an ASIC, a configured processor, optical storage, and the like. The one or more processors, either individually or collectively, can execute programs stored in the one or more memories to perform the operations and/or methods, including parts thereof, described throughout. For example, the one or more processors can execute programs stored in the one or more memories to perform the process 600 for operating a video game controller (e.g., 120) to perform controller-driven-AI-assisted video gameplay as discussed herein.

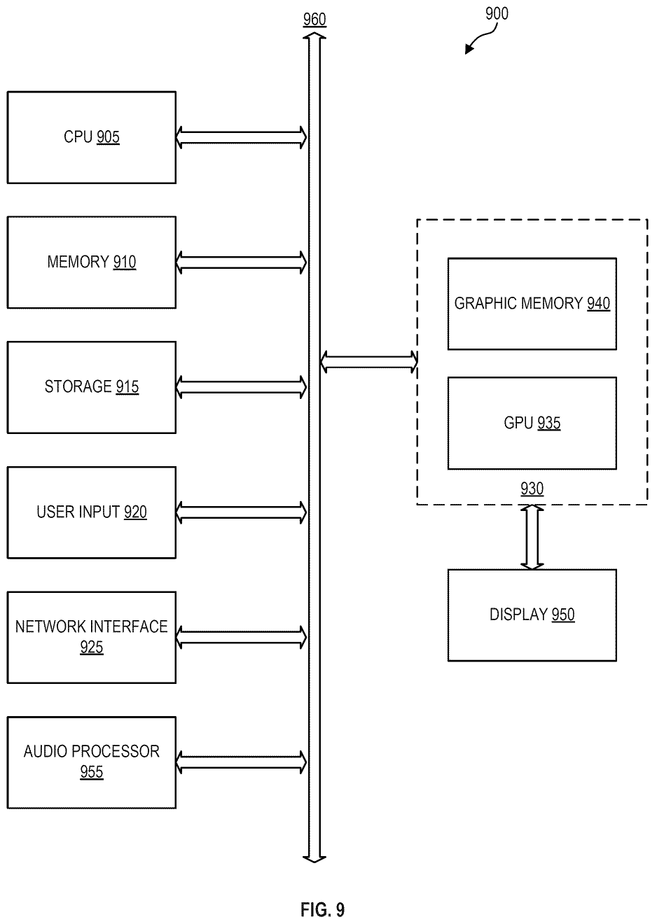

FIG. 9 illustrates an example of a computer system 900 suitable for implementing techniques of the present disclosure. The computer system 900 represents, for example, a user device (e.g., a touchscreen device or any other device described herein, above), a video game system, a backend set of servers, or other types of a computer system. The computer system 900 includes a central processing unit (CPU) 905 for running software applications and optionally an operating system. The CPU 905 may be made up of one or more homogeneous or heterogeneous processing cores. Memory 910 stores applications and data for use by the CPU 905 (including possible any of the AI models and any program codes of applications described herein above). Storage 915 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media (and may store any of the training data and/or user data described herein above). User input devices 920 communicate user inputs from one or more users to the computer system 900, examples of which may include keyboards, mice, joysticks, touch pads, touch screens, still or video cameras, and/or microphones. Network interface 925 allows the computer system 900 to communicate with other computer systems (including ones hosting any of the AI models described herein) via an electronic communications network and may include wired or wireless communication over local area networks and wide area networks such as the Internet. An audio processor 955 is adapted to generate analog or digital audio output from instructions and/or data provided by the CPU 905, memory 910, and/or storage 915. The components of computer system 900, including the CPU 905, memory 910, data storage 915, user input devices 920, network interface 925, and audio processor 955 are connected via one or more data buses 960.

A graphics subsystem 930 is further connected with the data bus 960 and the components of the computer system 900. The graphics subsystem 930 includes a graphics processing unit (GPU) 935 and graphics memory 940. The graphics memory 940 includes a display memory (e.g., a frame buffer) used for storing pixel data for each pixel of an output image. The graphics memory 940 can be integrated in the same device as the GPU 935, connected as a separate device with the GPU 935, and/or implemented within the memory 910. Pixel data can be provided to the graphics memory 940 directly from the CPU 905. Alternatively, the CPU 905 provides the GPU 935 with data and/or instructions defining the desired output images, from which the GPU 935 generates the pixel data of one or more output images. The data and/or instructions defining the desired output images can be stored in the memory 910 and/or graphics memory 940. In an embodiment, the GPU 935 includes 3D rendering capabilities for generating pixel data for output images from instructions and data defining the geometry, lighting, shading, texturing, motion, and/or camera parameters for a scene. The GPU 935 can further include one or more programmable execution units capable of executing shader programs.

The graphics subsystem 930 periodically outputs pixel data for an image from the graphics memory 940 to be displayed on the display device 950. The display device 950 can be any device capable of displaying visual information in response to a signal from the computer system 900, including CRT, LCD, plasma, and OLED displays. The computer system 900 can provide the display device 950 with an analog or digital signal.

In accordance with various embodiments, the CPU 905 is one or more general-purpose microprocessors having one or more processing cores. Further embodiments can be implemented using one or more CPUs 905 with microprocessor architectures specifically adapted for highly parallel and computationally intensive applications, such as media and interactive video game applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

As used herein, when an action is “based on” something, this means the action is based at least in part on at least a part of the something. As used herein, the terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 7, and 8 percent.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Various embodiments of this disclosure are described herein, including the best mode known for carrying out the disclosure. Variations of those embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A system comprising:
at least one processor; and
at least one memory storing instructions that, upon execution by the at least one processor, configure the system to:
receive, from a controller comprising controls manually actuatable by a user, controls actuation information associated with playing a video game;
determine accessibility information associated with the user, the accessibility information indicating a limitation to manual actuation of the controller;
generate a control output by using an artificial intelligence (AI) model, the AI model trained to assist video game users with controller inputs in association with one or more accessibility limits for using controllers, the control output generated based on the controls actuation information and the accessibility information; and
cause control of executing the video game based on the control output.

2. The system of claim 1, wherein the controls actuation information comprises at least one of:
hardware information of the controller;
one or more controls actuated by the user;
an amount of actuation of the one or more controls;
timing of the actuation of the one or more controls; or
duration of the actuation of the one or more controls.

3. The system of claim 1, wherein the AI model is further trained based on accessibility information of the user, and wherein the video game control compensates for the limitation to the manual actuation by the user of the controller.

4. The system of claim 1, wherein the controls actuation information corresponds to one or more of:
a reduced manual actuation of the controls relative to a baseline controls actuation related to the users without the limitation,
an excessive manual actuation of the controls relative to the baseline controls actuation related to the users without the limitation, or
no actuation of the controls.

5. The system of claim 4, wherein the control output comprises at least one of:
an amplified digital actuation corresponding to the reduced manual actuation of the controls;
a reduced digital actuation corresponding to the excessive manual actuation of the controls, or
the baseline controls actuation corresponding to no actuation of the controls.

6. The system of claim 1, wherein the control output is generated by further inputting a context of the video game to the AI model.

7. The system of claim 6, wherein the execution of the instructions further configures the system to:
receive gameplay data of the execution of the video game for the user and at least a subset of the controls actuation information in relation to the context of the video game; and
predict a video game action relevant to the gameplay data and the subset, wherein the control output is based on the video game action.

8. The system of claim 7, wherein the execution of the instructions further configures the system to:
overlay, on a screen, the predicted video game action during the gameplay.

9. The system of claim 7, wherein the execution of the instructions further configures the system to:
overlay, on a screen, the control output that corresponds to an adjusted set of manual actuations of the controller.

10. The system of claim 1, wherein the AI model is deployed on at least one of: a gaming console, a server accessible to the gaming console, or the controller.

11. The system of claim 1, wherein the execution of the instructions further configures the system to:
cause, based on the control output, a change to an actuation configuration of the controls of the controller; and/or cause, based on the control output, a change to a setting of the video game.

12. The system of claim 1, wherein the AI model is trained based on data associated with at least one of: a plurality of controllers, a plurality of video game titles, game play data of a plurality of users, and wherein the AI model generates the control output further based on that identifies at least one of: the controller, a type of the controller, the video game title, or a type of the video game.

13. The system of claim 1, wherein the execution of the instructions further configures the system to:
indicate, to a player in a multi-player video game, that the AI model is activated for the user;
automatically deactivate the AI model in a multi-player video game; or
deactivate the AI model based on user input of the user.

14. The system of claim 1, wherein the execution of the instructions further configures the system to:
activate an artificial intelligence (AI) accessibility agent associated with the user, the AI accessibility agent comprising the AI model, and configured convert the control output from the AI model to control actions associated with the video game; and
compare, using the AI accessibility agent, the controls actuation information with baseline controls actuation information to identify a subset of controls actuation information associated with user accessibility limitations, the baseline controls actuation information being associated with users without accessibility limitations.

15. A method for generating control output using an artificial intelligence (AI) model, the method comprising:
receiving, from a controller comprising controls manually actuatable by a user, controls actuation information associated with playing a video game;
determining accessibility information associated with the user, the accessibility information indicating a limitation to manual actuation of the controller;
generating a control output by using an artificial intelligence (AI) model, the AI model trained to assist video game users with controller inputs in association with one or more accessibility limits for using controllers, the control output generated based on the controls actuation information and the accessibility information; and
causing control of executing the video game based on the control output.

16. The method of claim 15, wherein receiving the controls actuation information associated with the user's accessibility comprises receiving at least one of:
a reduced manual actuation of the controls relative to a baseline controls actuation related to the users without accessibility issues,
an excessive manual actuation of the controls relative to the baseline controls actuation related to the users without accessibility issues, or
no actuation of the controls.

17. The method of claim 16, wherein generating the control outputs comprise at least one of:
generating, using the AI model, an amplified digital actuation corresponding to the reduced manual actuation of the controls;
generating, using the AI model, a reduced digital actuation corresponding to an excessive manual actuation of the controls, or
generating, using the AI model, the baseline controls actuation corresponding to no actuation of the controls.

18. The method of claim 15, further comprising:
inputting a context of the video game to the AI model;
receiving gameplay data of the execution of the video game for the user and at least a subset of the controls actuation information in relation to the context of the video game; and
predicting a video game action relevant to the gameplay data and the subset, wherein the control output is based on the video game action.

19. The method of claim 18, further comprising:
overlaying, via the AI model, the predicted video game action during the gameplay on to a display screen; and/or
overlay, on the screen, the control output that corresponds to an adjusted set of manual actuations of the controller.

20. One or more non-transitory computer-readable storage instructions that, upon execution by one or more processors, cause operations comprising:
receiving, from a controller comprising controls manually actuatable by a user, controls actuation information associated with playing a video game;
determining accessibility information associated with the user, the accessibility information indicating a limitation to manual actuation of the controller;
generating a control output by using an artificial intelligence (AI) model, the AI model trained to assist video game users with controller inputs in association with one or more accessibility limits for using controllers, the control output generated based on the controls actuation information and the accessibility information; and
causing control of executing the video game based on the control output.
